(19) United States
(12) Patent Application Publication
(10) Pub. No.: US 2025/0239116 A1
(43) Pub. Date: Jul. 24, 2025

(54) Multi-Lock Home Kit

(71) Applicant: Vivint LLC, Provo, UT (US)

(72) Inventors: Cecilee Petersen, Provo, UT (US); Stephen Edward Boynton, Provo, UT (US); Austin Matsuura, Provo, UT (US); Rikki Price, Provo, UT (US); Kris Nosack, Provo, UT (US)

(73) Assignee: Vivint LLC, Provo, UT (US)

(21) Appl. No.: 19/035,048

(22) Filed: Jan. 23, 2025

Related U.S. Application Data
(60) Provisional application No. 63/624,233, filed on Jan. 23, 2024.

(51) Int. Cl. G07C 9/00

(52) U.S. Cl. CPC G07C 9/00182

(57) ABSTRACT

A kit for securing a space with multiple doors and walls. The kit includes a controller to be mounted exterior to the enclosed space. The kit may include a first smart lock interface that can be mounted on an interior of a primary door and interface with a locking mechanism of the primary door. Furthermore, the kit may include a secondary smart lock interface that can be mounted on the interior of a secondary door and interface with a locking mechanism of the secondary door. Each of the controller, the first smart lock interface, and the secondary lock interface may cause one or more locks of the space to adjust lock states through an associated smart lock interface. Each smart lock and controller may have indicators for displaying a lock/unlocked state of each smart lock.

### CROSS REFERENCE

This application claims priority to U.S. Provisional Patent Application, 63/624,233, filed Jan. 23, 2024, and entitled MULTI-LOCK HOME KIT, which is incorporated by reference herein in its entirety.

### TECHNICAL FIELD

The current disclosure generally relates to smart home security systems. More specifically, the current disclosure relates to operational control of multi-lock smart home security systems.

### BACKGROUND

Various approaches have been developed for securing and controlling access to spaces with multiple doors. Traditional lock and key systems have been widely used, but they lack the convenience and flexibility of modern smart lock systems. Smart lock systems have emerged as a popular alternative, offering features such as remote access control, keyless entry, and integration with other smart home devices. A smart lock system often includes a smart lock controller that includes (i) a keypad mounted on an outside of a door and (ii) a thumb lock interface or adapter to a thumb turn or a deadbolt lever and installed on an inside door surface that communicates with the smart lock controller and is controlled thereby.

One approach involves using a single smart lock installed on the main entrance door of a space, such as a home or business. This smart lock is typically controlled through a mobile application or a centralized hub. While this approach provides convenience and enhanced security for the main entrance, it does not address the need for individual access control for multiple doors within the space. In situations where there are multiple doors of entry for entering different areas or rooms, smart locks may be installed on each door to enable independent access control. In other words, smart locks are installed on respective doors and operated independently to access entry into the space.

### SUMMARY

Disclosed herein are systems and methods capable of addressing shortcomings of existing smart locks. A system as described herein may include a primary smart lock installed on a main door (e.g., front door of a house) and one or more secondary smart locks (e.g., smart lock interfaces installed on non-front doors of a house). The primary smart lock may include two components: an exterior smart lock controller and an interior smart lock interface. The secondary lock may include an interior smart lock interface. According to an illustrative embodiment, the exterior controller may be configured to receive an input from a user to selectably transition one or more (e.g., all) smart locks installed to a respective one or more doors of a space (e.g., house) to a locked or unlocked state. Upon receiving the input from the user to selectably transition one or more smart locks at the space to the locked state, the exterior controller may transmit, either directly or indirectly, a control signal to one or more smart locks to cause the one or more smart locks to transition from an unlocked state to a locked state. In an embodiment, each lock (e.g., internal and external components) may include an indicator corresponding to status of each smart lock installed at the space. Each indicator may be configured to display an indication of a status or state (e.g., “locked,” “unlocked,” “armed,” and/or “unarmed”) of the corresponding smart lock.

In some aspects, a kit may include a controller configured to be mounted on an exterior of a space with multiple doors and one or more walls to enclose the space. A first smart lock interface may be configured to be mounted to an interior of a first door and configured to lock and unlock the first door. The first smart lock interface may further be configured to communicate with the controller such that a first signal communicated to the first smart lock interface from the controller causes the first smart lock interface to transition from an unlocked state to a locked state or from a locked state to an unlocked state. A second smart lock interface may be configured (i) to be mounted to an interior of a second door, and further be configured (ii) to communicate with the controller such that a second signal may be communicated to the second smart lock interface from the controller to cause the second smart lock interface to transition from an unlocked state to a locked state or from a locked state to an unlocked state.

One embodiment of a security system may include a controller configured to be mounted on an exterior of a space with multiple doors and one or more walls to enclose the space. A first smart lock interface may be configured to be mounted to an interior of a first door, and further be configured to lock and unlock a first door. The first smart lock interface may further be configured to communicate with the controller such that a first signal communicated to the first smart lock interface from the controller causes the first smart lock interface to transition from an unlocked stated to a locked state or from a locked state to an unlocked state. A second smart lock interface may be configured to be mounted to an interior of a second door, and further be configured to communicate with the controller such that a second signal communicated to the second smart lock interface from the controller may cause the second smart lock interface to transition from an unlocked state to a locked state or from a locked state to an unlocked state.

The first smart lock interface may be configured to fit over a manual thumb turn of a deadbolt on the first door, and be configured to actuate the manual thumb turn to lock or unlock the first door. In an embodiment, the first smart lock interface may enable manual or remotely controlled locking and unlocking. Remotely controlling may include being controlled by a controller disposed on an opposite side of a door on which the first smart lock interface may be secured.

One embodiment of a computer-implemented method may include receiving, by one or more processors, a lock status of one or more of smart locks associated with a structure. The processor(s) may display the lock status of the smart locks on an electronic display. The processor(s) may receive an indication to transition the smart locks to a locked state. An instruction may be transmitted to the smart locks to adjust each smart lock to the locked state. An updated lock status may be received from the smart locks associated with the structure. The updated lock status of the smart locks may be displayed on the electronic display.

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is a perspective view illustrating one embodiment of a security system inclusive of smart locks, according to an embodiment;

FIG. 2 is a block diagram of a multi-lock home kit, according to an embodiment;

FIG. 3A is a front view illustration of a primary smart lock including an exterior unit and an interior unit, according to an embodiment;

FIG. 3B is a front view illustration of a secondary smart lock optionally configured to communicate with the primary smart lock, according to an embodiment;

FIG. 4 is an illustration of an illustrative controller configured to control and operate circuitry of any one or more smart locks of a multi-lock home kit, according to an embodiment;

FIG. 5 is a perspective view of an interior unit of a secondary smart lock, according to an embodiment;

FIG. 6 is a flow diagram of an illustrative process for controlling and operating a multi-lock home kit, according to an embodiment;

FIG. 7A is a flow diagram of an illustrative process for controlling and operating a multi-lock home kit, according to an embodiment; and

FIG. 7B is a flow diagram of an illustrative process for controlling and operating a multi-lock home kit, according to an embodiment.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

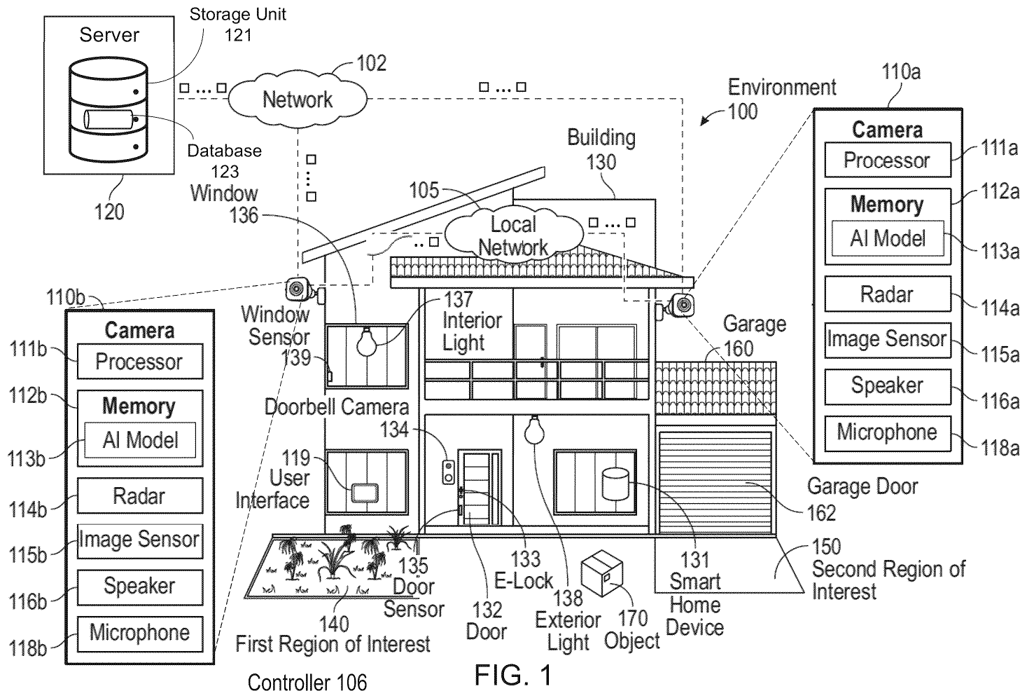

FIG. 1 illustrates an example environment 100 in which the present systems and methods may be implemented. The environment 100 may include a site that can include one or more structures, any of which can be a building 130, such as a home, office, warehouse, garage, and/or the like. The building 130 may include various entryways, such as one or more doors 132, one or more windows 136, and/or a garage 160 having a garage door 162. In some implementations, the environment 100 includes multiple sites, each corresponding to a different property or building attached or unattached to the building 130. In an example, the environment 100 includes a cul-de-sac including multiple homes.

The environment 100 may include multiple cameras, including a first camera 110a and a second camera 110b, referred to herein collectively as cameras 110. The cameras 110 may be attached or unattached to the building 130. The cameras 110 may communicate with each other over a local network 105. The cameras 110 may communicate directly or indirectly with a server 120 over a network 102 (e.g., a cloud network, mobile phone network, etc.). The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include or be communicatively coupled to a wide area network (“WAN”), a storage area network (“SAN”), a local area network (“LAN”) (e.g., a home network), an optical fiber network, the Internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™.

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, at least one processor 111a, a memory 112a, a radar sensor 114a, a speaker 116a, and a microphone 118a. Other sensors types, such as motion, proximity, or otherwise may be utilized. The memory 112a may include computer-readable, non-transitory instructions which, when executed by the processor 111a, cause the processor 111a to perform methods and operations described herein. The processor 111a may include one or more processors. The second camera 110b may include an image sensor 115b, at least one processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may store an AI model 113a that is accessed by the processors(s) 111a that are executing an AI process (e.g., neural network). The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field-of-view of the first camera 110a, a field-of-view of the second camera 110b, a field-of-view of another sensor, or the like) based on data from the first camera 110a, the second camera 110b, and/or other sensors.

The memory 112b of the second camera 110b may store an AI model 113b that is accessed by the processors(s) 111a that are executing an AI process (e.g., neural network). The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time-of-flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The environment 100 may include a user interface 119. The user interface 119 may be part of a device, such as a mobile phone, a tablet, a laptop, wall panel, or other device. The user interface 119 may communicatively connect to or communicate with the cameras 110 via the network 102 or the local network 105. The user interface 119 may allow a user to access sensor data of the cameras 110. In an example, the user interface 119 may allow the user to view a field-of-view of the image sensors 115 and hear audio data from the microphones 118. In an example, the user interface may allow the user to view a representation, such as a point cloud, of radar data from the radar sensors 114. The image sensors 115 may include the use of visible and/or non-visible spectrums (e.g., infrared).

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to two or more sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field-of-view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform, initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the cameras 110 may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like. Moreover, the cameras 110 may determine direction of travel of a person, object, vehicle, or the like in arriving to and leaving from the field-of-view of the cameras 110 and/or the property.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields-of-view of the image sensors 115 of the cameras 110, fields-of-view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields-of-view of the sensors of the cameras 110 the garden is located. In some implementations, the first region of interest 140 may be determined by user input selecting, within the fields-of-view of the sensors of the cameras 110 on the user interface 119, where the garden is located. Similarly, the second region of interest 150 may be determined by user input indicating, on the user interface 119, that the driveway should be a region of interest and the AI models 113 determining where in the fields-of-view of the sensors of the cameras 110 the driveway is located. In some implementations, the second region of interest 150 may be determined by user input selecting, on the user interface 119, within the fields-of-view of the sensors of the cameras 110, where the driveway is located.

In response to determining that a combination of data and/or determinations from the multiple sensors indicates that a detected human is, has, intends to, and/or may otherwise perform one or more suspicious acts, is unknown/unrecognized, has entered a restricted area/zone such as the first region of interest 140 or the second region of interest 150, the cameras 110 may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like), such as executing a configurable scene for a user, activating lighting, playing music, opening or closing a window covering, turning a fan on or off, locking or unlocking the door 132, lighting a fireplace, powering an electrical outlet, turning on or play a predefined channel or video or music on a television or other device, starting or stopping a kitchen appliance, starting or stopping a sprinkler system, opening or closing a garage door 103, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the cameras 110 are configured to play and/or otherwise emit one or more sounds in response to detecting the presence of a human within an area. For example, the cameras 110 may play one or more sounds selected to deter a detected person from an area around a building 101, property, and/or object. The cameras 110, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The cameras 110, in some implementations, stores and/or has access to a library comprising a plurality of different sounds and/or a set of dynamically generated sounds so that the controller 106 may vary the different sounds over time, not using the same sound often. In some embodiments, varying and/or layering sounds allows a deter sound to be more realistic and/or less predictable. One or more of the sounds may be selected to give a perception of human presence in the building 101, a perception of a human talking over an electronic speaker device, or the like which may be effective at preventing crime and/or property damage.

For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?”, a female with a country accent saying “hello there”, a dog barking, a teenager saying “don't you know you're on camera?”, and/or a man shouting “hey!” or “hey you!”, or the like. The sounds, questions, statements, voices, etc. may change based on distance, location, recognitions, size, object(s) or otherwise detected by the cameras 110 (or other computing system with which the cameras 110 communicate image data).

In some implementations, the cameras 110 may dynamically generate one or more sounds (e.g., using machine learning and/or other artificial intelligence, or the like) with one or more attributes that vary from a previously played sound. For example, the cameras 110 may generate sounds with different verbal tones, verbal emotions, verbal emphases, verbal pitches, verbal cadences, verbal accents, or the like so that the sounds are said in different ways, even if they include some or all of the same words. In some embodiments, the cameras 110 and/or a remote computer 125 may train machine learning on reactions of previously detected humans in other areas to different sounds and/or sound combinations (e.g., improving sound selection and/or generation over time).

The cameras 110 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The cameras 110, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the cameras 110 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the cameras 110 may play a primary sound layered and/or overlapping with one or more secondary, tertiary, and/or background sounds, varying the sounds and/or the combination from one or more previously played sounds and/or combinations, or the like.

The cameras 110, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The cameras 110, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the cameras 110 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the cameras 110 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120, may include image processing capabilities and/or radar data processing capabilities for analyzing images, videos, and/or radar data that are captured with the cameras 110. The server may be communicably coupled or include one or more storage units 121 which may include one or more databases 123. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the cameras 110 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

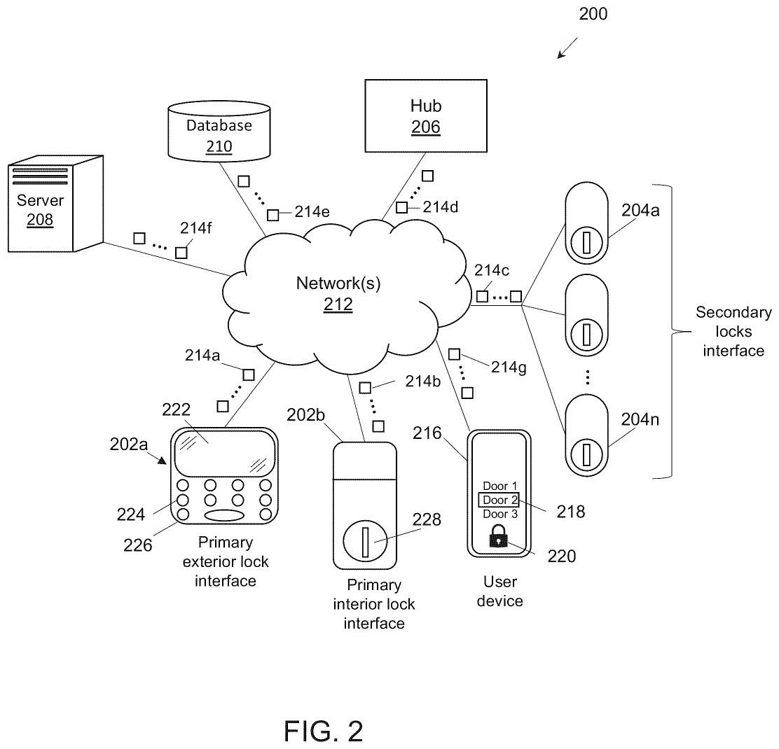

Turning now to FIG. 2, a system 200, including multiple communicatively coupled smart locks for securing an enclosed space (e.g., a building) is shown, according to an embodiment. The system 200 may be located partially or entirely within the enclosed space. The enclosed space may be, for example, any building, edifice, or enclosure including one or more walls and one or more entrances. In the present disclosure, the building may include, but is not limited to, a home, office, store, business, courtyard, etc. The system 200 within and engaged to the building may include a primary exterior lock interface 202a, a primary interior lock interface 202b, one or more secondary lock interfaces 204a-204n (collectively 204), and a hub 206 located internal and/or external from the space. The system 200 may further include a server 208, a database 210, one or more networks 212 (e.g., a local network may be part of the system 200 provided by the security system), and/or a user device 216. The various devices and components of the system 200 may communicate with one another via the one or more networks 212. The system 200 may be used to access, view, control, and/or adjust one or more locks of the doors that are engaged to the primary interior lock interface 202b, and the secondary lock interfaces 204 from a single location exterior to the building (e.g., the primary exterior lock interface 202a). By way of example, and for ease of description, the single location exterior to the building may be a primary door, which may be a front door, a gate, or any other entrance of the enclosed space. According to some embodiments, the primary door may be a primary exit/entrance through which a user of the system 200 primarily exits/enters the building. In some embodiments, the primary door may be a garage door. In addition to the primary door, the enclosed space may include one or more secondary doors. Secondary doors may be entrances or exits from the building that do not serve as the user's primary means of entering/exiting the building. Secondary doors may include a side door, a side gate, a back door, a garage door, etc. Though the term “door” is used in various terms of the present disclosure, it should be understood that the any mechanism or means for entering/exiting the building may be encompassed in the term “door.” For example, “door” may encompass sliding doors, rotating doors, windows, gates, overhead doors, barn doors, etc.

For ease of description and understanding, FIG. 2 depicts the system 200 as having one or a small number of each component. Embodiments may, however, include additional or alternative components, or omit certain components, from those of FIG. 2 and still fall within the scope of this disclosure. As an example, it may be common for embodiments to include multiple servers 208 and/or multiple databases 210 that are communicably coupled to or operated by the server 208 and the primary exterior lock interface 202a through the network 212. Embodiments may include or otherwise implement any number of devices capable of performing the various features and tasks described herein. For instance, FIG. 2 depicts the database 210 as hosted as or operated as a distinct computing device from the server 208, though, in some embodiments, the server 208 may include an integrated database 210 hosted by the server 208.

The system 200 may include or utilize one or more networks 212, which may include any number of internal networks, (e.g., LANs) external networks (e.g., WANs), private networks (e.g., intranets, VPNs), and public networks (e.g., Internet). The network(s) 212 may include various hardware and software components for hosting and conducting communications amongst the components of the system 200. Moreover, non-limiting examples of such internal or external networks 212 may include a Local Area Network (LAN), Wireless Local Area Network (WLAN), Metropolitan Area Network (MAN), Wide Area Network (WAN), and the Internet. The communication over the networks 212 may be performed in accordance with various communication protocols, such as Transmission Control Protocol and Internet Protocol (TCP/IP), User Datagram Protocol (UDP), and IEEE communication protocols, among others. Additional, and/or alternative communication protocols that may be used by the network(s) 212 may include Wi-Fi, Bluetooth, Zigbee, Z-Wave, Thread, Insteon, LoRaWAN, KNK, DALI, and/or UPnP.

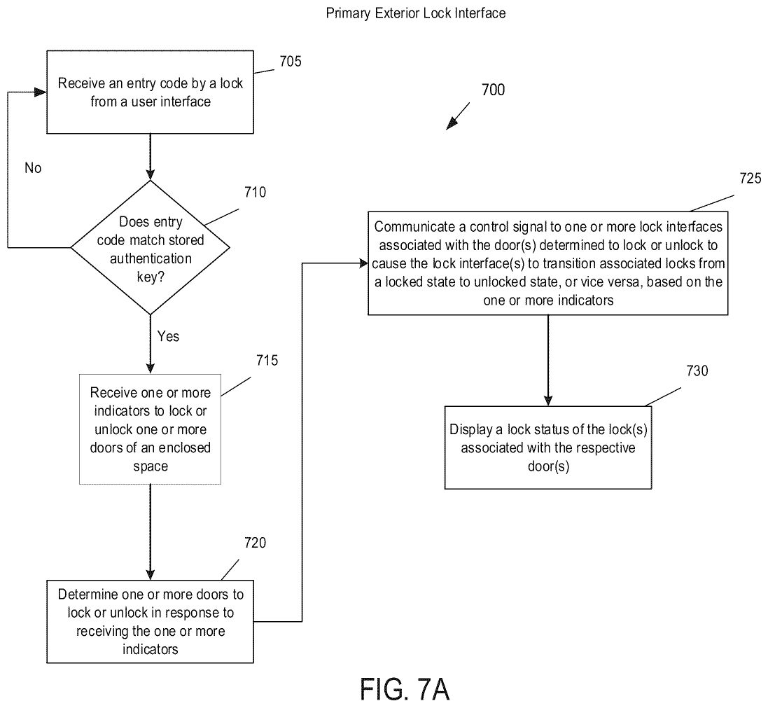

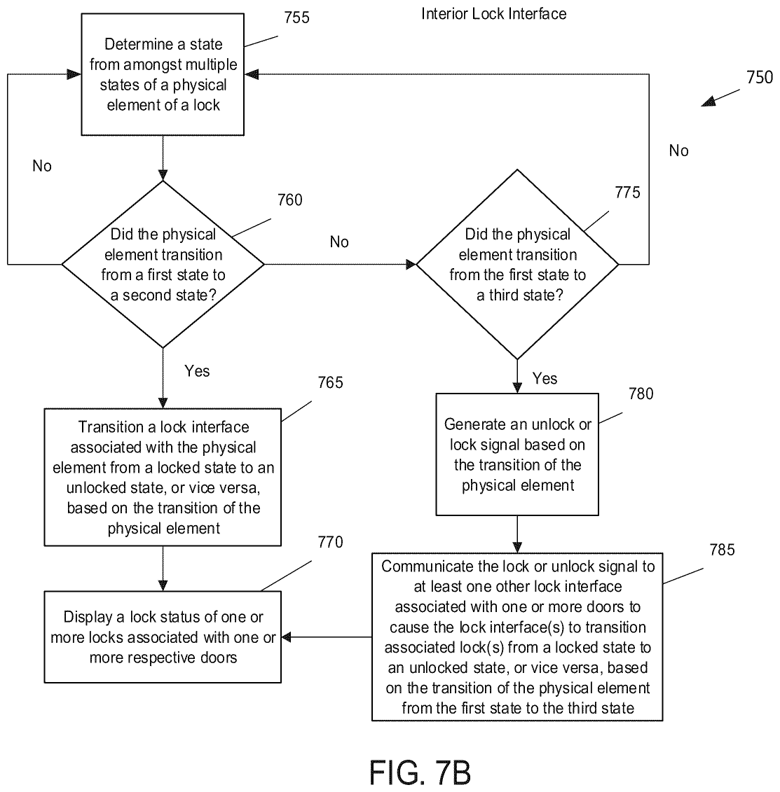

The server 208 may include one or more processors that execute one or more software programs to perform various processes (e.g., the process 700 of FIG. 7A and/or the process 750 of FIG. 7B). The server 208 may include processor(s) and non-transitory, computer readable medium including instructions, which, when executed by the processor(s), cause the processor to perform methods disclosed herein. The processor(s) may include any number of physical, hardware processor. Although FIG. 2 shows only a single server 208, the server 208 may include any number of computing devices. In some cases, the computing devices of the server 208 may perform all or portions of the processes described herein to support the system 200. The server 208 may include computing devices (e.g., processors) operating in a distributed or cloud computing configuration and/or in a virtual machine configuration. It should also be appreciated that, in some embodiments, one or more functions of the server 208 may be partly or entirely performed by the primary exterior lock interface 202a or any other component (e.g., the hub 206).

The hub 206 may be configured to perform functions similar to, or the same as, the controller 106 of FIG. 1, as previously described. The hub 206 may be communicatively coupled with the various components of the system 200 and/or other smart devices of the building directly or indirectly (e.g., through the network(s) 212, as shown in FIG. 2). By way of example, the hub 206 may receive control signals from, and transmit the control signals to, the primary exterior lock interface 202a, the primary interior lock interface 202b, and/or the secondary lock interfaces 204. The hub 206 may be configured to receive various communication protocol signals and translate the various communication protocol signals into control signals to control the various components of the system 200.

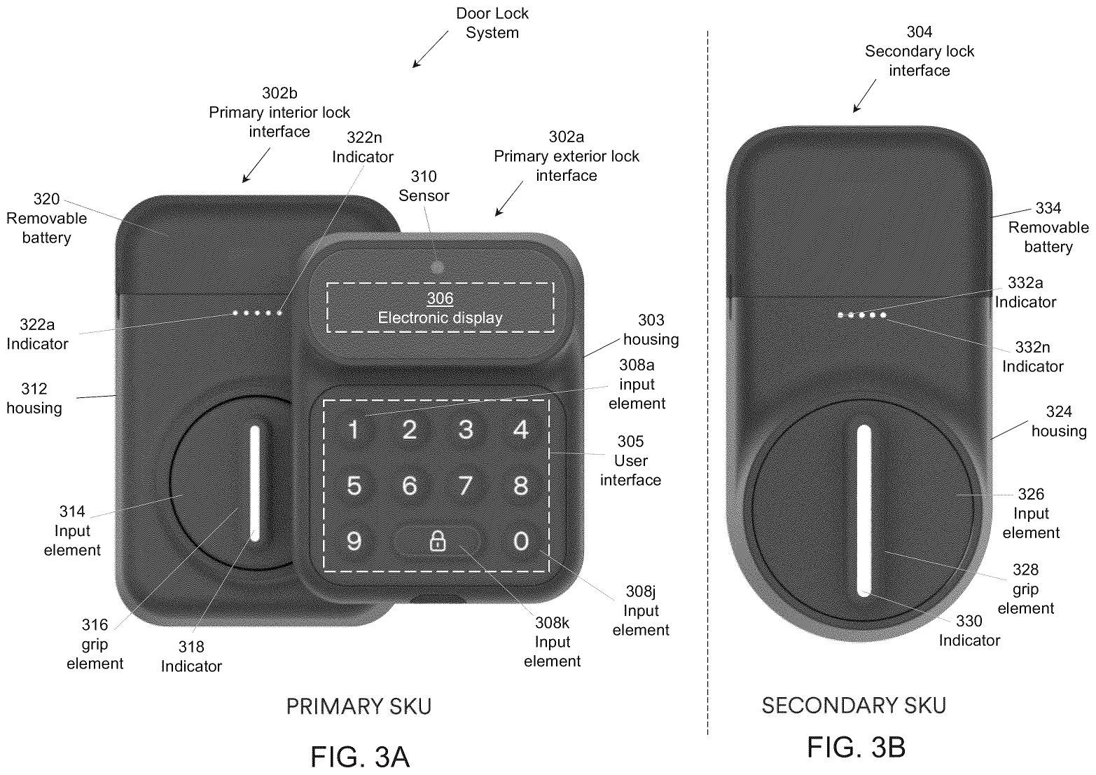

The primary exterior lock interface 202a (e.g., a controller) may be any type of electronic device including hardware components (e.g., one or more processors, non-transitory memory, user interface, housing, etc.) and software components capable of performing the various processes and tasks described herein. The primary exterior lock interface 202a may include a user input device 224 for receiving instructions and interactions from the user. The primary exterior lock interface 202a may include an electronic display 222 for presenting information to the user. By way of example, the primary exterior lock interface 202a may be distinct from the hub 206. Alternatively, the primary exterior lock interface 202a may perform the same or the similar functions as the hub 206. The hub 206 may be configured to perform the same or similar functions as the controller 106 of FIG. 1. Non-limiting examples of the primary exterior lock interface 202a include smart home devices (e.g., smart locks), personal computers (e.g., laptop computers, desktop computers), server computers, mobile devices (e.g., smartphones, tablets), VR devices, and gaming consoles, smart watches, among other types of electronic devices. In an illustrative embodiment, the primary exterior lock interface 202a is configured to operate in conjunction with the primary interior lock interface 202b door lock so as to function as a smart lock for the primary door of the enclosed space. As will be described in greater detail in FIG. 3A, the primary exterior lock interface 202a may include an electronic display 222, a user input device 224 (e.g., keypad), a communication module (not shown), and a physical housing 226.

When installed, the primary exterior lock interface 202a may be mounted (e.g., located, installed, placed, attached, integrated) on the exterior of the primary door (e.g., positioned near or at a handle, lock, and/or doorknob). Alternatively, the primary exterior lock interface 202a may be mounted on a wall of the enclosed space. In general, the primary exterior lock interface 202a may be positioned anywhere that enables communications with the primary interior lock interface 202b wirelessly or via a wired connection.

The primary exterior lock interface 202a may include one or more computing devices that execute one or more software programs to perform various processes (e.g., the process 700 of FIG. 7A and/or the process 750 of FIG. 7B). The primary exterior lock interface 202a may include a processor and non-transitory, computer-readable medium or memory including instructions, which, when executed by the processor, causes the processor to perform methods disclosed herein. The processor may include any number of physical, hardware processors that execute software to perform the functions described herein.

The primary interior lock interface 202b may be (or include) any type of electronic device comprising hardware components (e.g., one or more processors, non-transitory storage, etc.) and software executable by one or more processors capable of performing the various processes and tasks described herein. Non-limiting examples of the computing devices of the primary interior lock interface 202b include smart home devices (e.g., smart locks), personal computers (e.g., laptop computers, desktop computers), server computers, mobile devices (e.g., smartphones, tablets), VR devices, and gaming consoles, smart watches, among other types of electronic devices. The primary interior lock interface 202b may include a grip element 228 for receiving instructions and/or indications from the user. In an illustrative embodiment, the primary interior lock interface 202b is considered an interior smart lock for the primary door, where the interior smart lock interface 202b is physically configured to engage a feature (e.g., thumb turn) of a door lock so as to electronically lock and unlock the door lock (e.g., deadbolts). As will be described in greater detail in FIG. 3A, the primary interior lock interface 202b may include one or more indicators, a user input, a communication module, a lock engagement member, and a physical housing. The primary interior lock interface 202b may be mounted (e.g., located, installed, placed) on an interior of the primary door(s) and physically engage a portion of the door lock so as to control locking and unlocking the door lock, as further described herein.

The primary interior lock interface 202b may include one or more processors configured to execute one or more software programs to perform various processes (e.g., the process 700 of FIG. 7A and/or the process 750 of FIG. 7B). The primary interior lock interface 202b may include a processor and non-transitory, computer-readable medium including instructions, which, when executed by the processor, cause the processor to perform methods disclosed herein (e.g., causing a locking mechanism to transition from a locked state to an unlocked state, and vice versa). The processor may include any number and type of processors. In some cases, the computing devices of the primary interior lock interface 202b may perform at least a portion of the processes of the hub 206 and/or the primary exterior lock interface 202a. The primary interior lock interface 202b may also include various hardware mechanisms (e.g., actuators) to lock or unlock a mechanical, electromechanical, electromagnetic, or other type of lock of the primary door, as shown in greater detail in FIG. 3A. The primary exterior lock interface 202a and primary interior lock interface 202b may be in communication with one another such that a user who enters a command (e.g., unlock) into the interface 202a causes the interface 202b to perform an action (e.g., rotate a thumb turn of a deadbolt lock).

In addition, the primary interior lock interface 202b may include one or more indicators (e.g., speakers, lights, displays, haptic machines, etc.) to indicate a state of one or more locks (e.g., the primary interior lock interface 202b and/or the secondary lock interfaces 204a-204n). By way of example, the primary interior lock interface 202b may include multiple illumination devices (e.g., LEDs) on or in a housing of the primary interior lock interface 202b that illuminate respective indicators (e.g., numerals 1-6, spots, words, etc.) that assist a user with knowing which doors and/or windows are locked. More specifically, each illumination device may correspond to a smart lock (e.g., door lock configured with primary or secondary lock interfaces 202 or 204) of the building. In an embodiment, each illumination device may have two states, a first state (e.g., OFF) associated with a locked state of the smart lock and the second state (e.g., ON) associated with an unlocked state of the smart lock. In this way, the user may quickly identify, based on the state of the illumination devices that are illuminating or not illuminating the indicators, the state of each smart lock of the building from a central location at a glance of the lock interfaces 202 and 204. For example, primary interior lock interface 202b may receive an indication of the state of each of the smart lock interfaces 202 and 204 of the system 200 from each of the lock interfaces 202 and 204 directly or indirectly, from the primary exterior lock interface 202a, the hub 206, and/or the server 208.

The primary interior lock interface 202b may include one or more sensors (e.g., cameras, proximity sensors, radar, sonar, infrared, etc.) to determine a presence of the user. Responsive to receiving an indication, from the one or more sensors, of the presence of the user, the indicators may display an indication of the sensed presence of the user. In certain embodiments, the primary exterior lock interface 202a also includes indicators that may function substantially in the same manner as the indicators of the primary interior lock interface 202b. Likewise, the secondary lock interfaces 204a-204n may also include indicators that function substantially in the same manner as the indicators of the primary interior lock interface 202b.

The primary interior lock interface 202b may include a specialized and/or configurable physical housing to position over a manual thumb turn of a deadbolt of a door. The primary interior lock interface 202b may include one more actuators that are electronically controlled to automatically switch states (e.g., lock or unlock) in response to received one or more control signals (e.g., from the primary exterior lock interface 202a, the hub 206, and/or the primary interior lock interface 202b). For example, the primary interior lock interface 202b may receive a control signal from the primary exterior lock interface 202a to transition a state of the primary door from an unlocked state to a locked state. Upon receiving the control signal at the primary interior lock interface 202b, the primary interior lock interface 202b actuates an actuator of the primary interior lock interface 202b to rotate the manual thumb turn (or the deadbolt directly) of the primary door into a locked position. In an alternative embodiment, the primary exterior lock interface 202a may receive the control signal or generate the control signal in response to a user interfacing directly with the primary exterior lock interface 202a and communicate the control signal to the primary interface lock interface 202b (and/or one or more secondary lock interface 204) to cause the state of associated locks to change.

In some embodiments, the primary interior lock interface 202b may be configured to actuate the lock of a door in an alternative manner engaging a manual thumb turn of the lock (e.g., deadbolt) of the primary door. In such embodiments, the primary interior lock interface 202b may include an integrated deadbolt and/or be integrated into or on the primary interior door. The integrated deadbolt may be physically and/or mechanically coupled to one or more actuators of the primary interior lock interface 202b, and function to adjust a position of the integrated deadbolt from a locked or unlock position or vice versa. In integrated deadbolt embodiments, the primary interior lock interface 202b may function in substantially the same manner as the embodiments in which the primary interior lock interface 202b fits over the manual thumb turn. Upon the primary interior lock interface 202b transitioning from an unlocked state to a locked state or a locked state to an unlocked state, an indicator corresponding to the primary interior lock interface 202b may transition states (e.g., unlit to lit, lit to unlit, change colors, etc.), as well. Likewise, an indicator on each additional smart lock interface (for example secondary lock interface 204a and/or the primary exterior lock interface 202a) adjust states as well. Upon the primary interior lock interface 202b changing lock states, especially if manually locked or unlocked, the primary interior lock interface 202b may transmit a signal indicative of the change of lock state. The additional smart locks may receive the signal transmitted from the primary interior lock interface 202b indicating the change in lock state, and in response to receiving the transmitted signal indicating the change in lock state, the secondary smart lock interfaces 204 may change the state of the indicator corresponding to the primary interior lock interface 202b. This method (e.g., changing lock states, transmitting changed locked state, updating corresponding lock status indicator) may be executed by any of the smart locks of the system 200.

By way of example, the primary exterior lock interface 202a may function as a control point to adjust the lock state of some or all smart locks of the building. For example, the primary exterior lock interface 202a may be interacted with by the user of the primary exterior lock interface 202a to command some or all of the smart locks of the building to change lock states. In response to receiving the command by the user, the primary exterior lock interface 202a may transmit a control signal number to some or all of the smart locks of the building (e.g., the primary interior lock interface 202b and the secondary lock interfaces 204a-204n) either directly or indirectly (e.g., via the hub 206). In some embodiments, the primary exterior lock interface 202a transmits an instructional signal or command number to one or more of the other smart locks (e.g., secondary interior lock interface(s) 204) and the smart lock(s) applies a control signal to cause an associated actuator to adjust the state of the corresponding lock. In other embodiments the primary exterior lock interface 202a may transmit an instructional signal number to the hub 206, which interprets the instructional signal and transmits a corresponding control signal number to the appropriate smart locks. The primary exterior lock interface 202a may be used to lock/unlock some all of the smart locks by broadcasting signals to smart locks or communicating the signals to individual smart locks that are network addressable.

In response to receiving an indication that the state of one or more smart lock has changed, a corresponding indicator for each smart lock on each of the smart locks (e.g., on secondary interior lock interfaces 204) transitions to a state that corresponds with the current state of each respective smart lock.

In various embodiments, each smart lock of the building may serve as a central location to control one or more other smart locks of the building. In such embodiments, each smart lock of the building may function in substantially the same manner as the primary exterior lock interface 202a, as described above. By way of example, the primary interior lock interface 202b may be used to alter the state of one or more smart locks of the system 200. Likewise, each of the secondary interior lock interfaces may be used to adjust the state of each smart lock of the system 200.

In some embodiments, the primary exterior lock interface 202a may be configured to require a password authentication from the user through a user input of the primary exterior lock interface 202a. The password may depend on the type of user interface on the primary exterior lock interface 202a. If the user interface is a keypad, the password may be a sequence of digits. If a camera is on the primary exterior lock interface 202a, a facial recognition may be considered a password. Other biometrics, swipes, or passwords may be possible. Responsive to receiving a user input through the input of the primary exterior lock interface 202a, the primary exterior lock interface 202a may compare the user input to a stored (either locally or remotely) authenticator key. In response to the user input matching the stored authenticator key, the primary exterior lock interface 202a may be used to adjust the lock state of any smart lock on the system 200. The primary exterior lock interface 202a may give one or more indications that the user input matches the stored authenticator. For example, the primary exterior lock interface 202a may present an audible indication of a match, a visual indication of a match, and/or a haptic indication of a match.

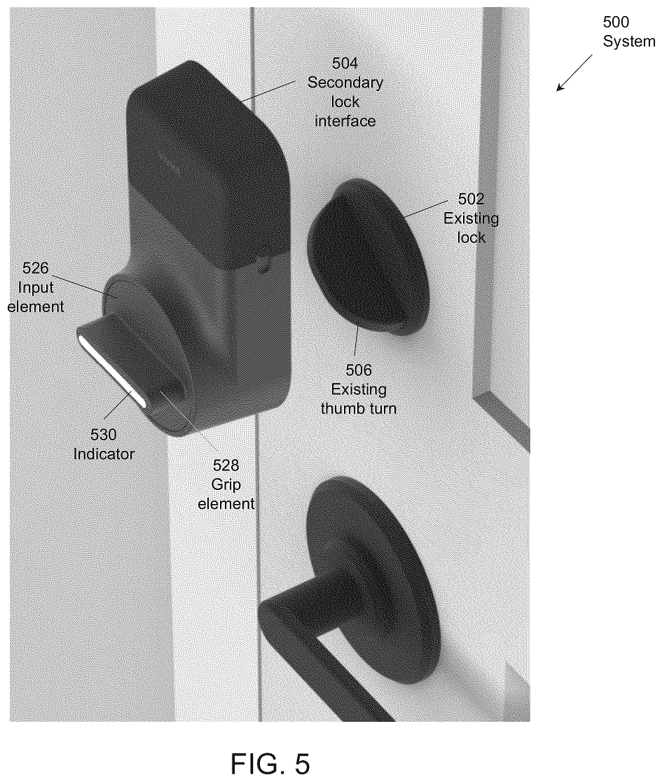

For ease of description, the secondary lock interfaces 204a-204n are described in the singular. However, the description of the secondary lock interface 204a may be extended to any or all secondary lock interfaces 204a-204n. The secondary lock interface 204a may be (or include) any type of electronic device comprising hardware components (e.g., one or more processors, non-transitory storage, wireless communication electronics, etc.) and software components or modules configured to perform the various processes and tasks described herein. Non-limiting examples of the computing devices of the secondary lock interface 204a and computing devices that may interact therewith to support the functions thereof include smart home devices (e.g., smart locks), personal computers (e.g., laptop computers, desktop computers), server computers, mobile devices (e.g., smartphones, tablets), smart watches, among other types of electronic devices. In an exemplary embodiment, the secondary lock interface 204a is an interior smart lock for the secondary door. As will be described in greater detail in FIG. 3B and FIG. 5, the secondary lock interface 204a may include a user display, a user input, a communication module, a thumb turn interface and a physical housing. The secondary lock interface 204a may be mounted (e.g., located, installed, placed) on an interior of the secondary door(s) at a lock and/or thumb turn thereof.

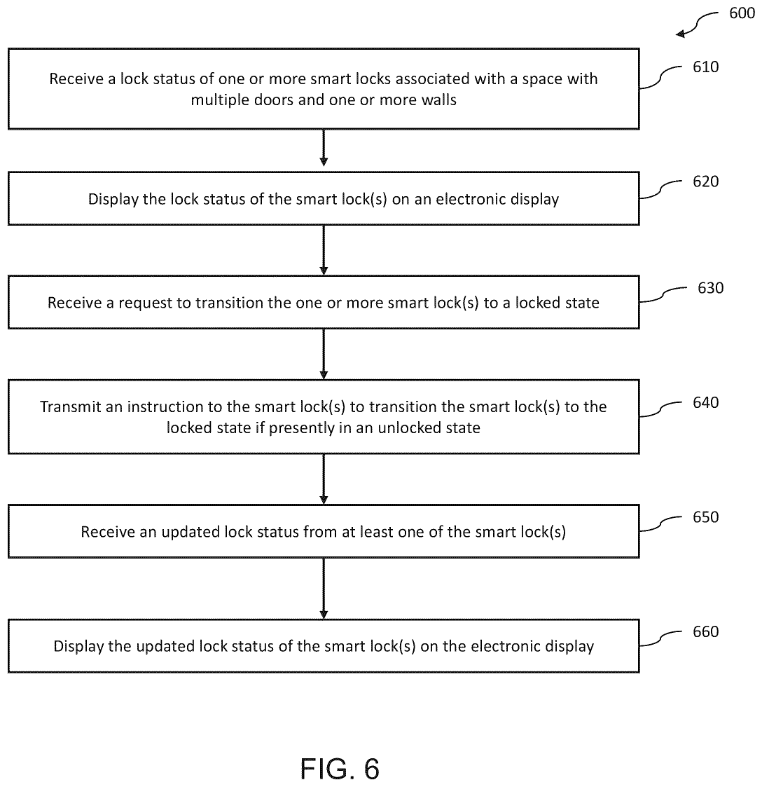

The secondary lock interface 204a may include at least one processor that executes one or more software programs to perform various processes (e.g., the process 700 of FIG. 7A and/or the process 750 of FIG. 7B). In other embodiments, the secondary lock interface 204a may enable a mobile computing device (e.g., cellular device) to be communicatively coupled to a locking mechanism to communicate control signals therewith to cause the secondary lock interface 204a to change from a lock state to an unlock state and vice versa. The system 200 may include any number of secondary lock interfaces 204. In some cases, the computing devices of the secondary lock interface 204a may be configured to perform all or portions of the processes of the hub 206, the primary exterior lock interface 202a, and/or the primary interior lock interface 202b. The secondary lock interface 204a may also include various hardware (e.g., actuators) to lock or unlock a lock of the secondary door, as shown in greater detail in FIG. 3B and FIG. 6. In addition, the secondary lock interface 204a may include one or more indicators (e.g., speakers, lights, displays, haptic devices, etc.) to indicate a state of one or more smart locks (e.g., the primary interior lock interface 202b and other secondary interior lock interfaces 204). By way of example, the secondary lock interface 204a may include multiple illumination devices (e.g., LEDs) on a housing thereof. Each illumination device may correspond with a different smart lock of the building. Each illumination device may have two states, a first state (e.g., illumination ON) associated with a locked state of the smart lock and the second state (e.g., illumination OFF) associated with an unlocked state of the smart lock. In this way, the user may quickly identify based on the indicators the state of each smart lock of the building from a central location.

The user device 216 (e.g., a mobile electronic device, such as a smartphone) may be any type of electronic device comprising hardware components (e.g., one or more processors, non-transitory storage medium, user interface) and software components capable of performing the various processes and tasks described herein. By way of example, the user device 216 is distinct from the computing device of FIG. 1, however, the user device 216 may be the same computing device 108 of FIG. 1, in which case the description is incorporated herein. Non-limiting examples of the user device 216 include personal computers (e.g., laptop computers, desktop computers), server computers, mobile devices (e.g., smartphones, tablets), VR devices, and gaming consoles, smart watches, among other types of electronic devices. In an illustrative embodiment, the user device 216 is a mobile electronic device executing one or more mobile applications that are configured to communicate with (e.g., transmit to and receive from) the various components of the system 200. The user device 216 may include an electronic display, a user interface, communication electronics, and a physical housing.

The user device 216 may include one or more computing devices configured to execute one or more software programs (e.g., mobile applications or apps) to perform various processes (e.g., process 700 of FIG. 7A and/or the process 750 of FIG. 7B). In some embodiments, the user device 216 may be a computer or computing device capable of performing the same or similar methods disclosed herein as performed by the user device 216. The user device 216 may include a processor and non-transitory, computer-readable medium including instructions, which, when executed by the processor, causes the processor to perform methods disclosed herein. Although FIG. 2 shows only a single user device 216, the user device 216 any include any number of devices associated with one or more users. In some cases, the computing devices of the user device 216 may perform all or portions of the processes of the primary exterior lock interface 202a, the primary interior lock interface 202b, the secondary lock interfaces 204a-204n, and/or the hub 206.

By way of example, the user of the system 200 may interact with the user device 216 to select one or more selectable elements 218 or buttons (each element 218 may be associated with a corresponding smart lock/door) to adjust from a first state (e.g., unlocked) to a second state (e.g., locked). The user may then select the element 220 to indicate whether to adjust the corresponding smart lock/door from the first state to the second state or the second state to the first state. In response to receiving the indications of the selected elements 218, 220, the user device 216 transmits control signals (either directly or indirectly) to the various locks/doors corresponding to the selected element 218 to execute the indicated transition between states as indicated by the selected elements 218, 220. In an embodiment, rather than having to interact with multiple elements 218, 220, the elements 218 may control both selection and state of the smart lock/door by, for example, holding the element 218 for a certain period of time or tap an element multiple times within a maximum time period (e.g., 2 taps within 0.5 seconds). Other user interface elements and processes for interacting with these elements may be provided and utilized in performing the locking and unlocking.

Control and informational signals may be transmitted between the components of the system 200. For example, the signals 214a, 214b, 214c, 214d, 214e, 214f, and/or 214g may be transmitted between and amongst components through the network(s) 212. As described herein, the signals 214a-214g may be transmitted utilizing any suitable communication protocol. According to illustrative embodiments, the signals 214a-214g may be transmitted directly between components of the system 200. Alternatively or additionally, the signals 214a-214g may be transmitted from a smart lock in response to a user changing a lock state thereof or to a single component (e.g., the hub 206 and/or the primary exterior lock interface 202a) and then relayed from the single component to one or more other components of the system 200.

Turning now to FIG. 3A, a door smart lock system 300 may include a primary exterior lock interface 302a and a primary interior lock interface 302b for controlling one or more locks associated with a building or other structure are shown. The primary exterior lock interface 302a and the primary interior lock interface 302b may be components that are packaged and sold as a kit. As described with regard to FIG. 2, the primary exterior lock interface 302a may be configured to be mounted to an exterior or front side of a door of the building, and the primary interior lock interface 302b may be configured to mount to an interior or back side of the door of the building. To avoid confusion, the exterior or exterior side of the door of the building may be considered outside the building, and the interior or interior side of the door of the building may be considered inside the building such that a person entering the building approaches the exterior side of the door and a person exiting the building approaches the interior side of the door. In various embodiments of the current disclosure the primary exterior lock interface 302a may be mounted to the exterior of the primary door of the building, the primary exterior lock interface 302a may also be mounted to an exterior surface of the building or other structure exterior to the building. In some embodiments, the primary exterior lock interface 302a is a mobile computing device and not mounted to any structure. Likewise, the primary interior lock interface 302b may be mounted to the interior of the building at a position other than an interior of the door. For example, the primary interior lock may be mounted on a door frame of the primary lock, a wall of the building, or located on a horizontal surface. However, given that the primary interior lock interface 302b is to physically lock and unlock a lock (e.g., deadbolt) of the door, at least a portion of the primary interior lock interface 302b is to engage with a lock control mechanism of the door to enable a user to lock and unlock the door, as further described herein.

In an alternative embodiment, the primary exterior lock interface and the primary interior lock interface may be configured to replace an existing lock or at least a portion thereof (e.g., replace a thumb turn of the existing lock) such that the primary exterior lock interface and the primary interior lock interface may both connect to and/or engage with the respective exterior and interior sides of the door along with directly or indirectly connecting with and/or engaging one another via connection components (e.g., bolts) and/or otherwise. In an embodiment, communications between the primary interior and primary exterior lock interfaces may be wireless or wired (e.g., optionally via a plug-in connector that extends through the door via a lock region. In an embodiment, a secondary interior lock interface may be configured to retrofit an existing lock such that the secondary interior lock interface engages with a thumb turn of a deadbolt lock, replaces a portion of or the entire lock. As previously described, the secondary interior lock interface may be configured to enable a user to manually or cause a signal to automatically rotate the thumb turn to a locked state or an unlocked state. If the secondary interior lock interface is configured to replace a portion of or an entire lock, the secondary interior lock interface may be configured to engage both the interior and exterior sides (i.e., indoor and outdoor surfaces) of the door.

The primary exterior lock interface 302a may include a housing 303 that contains various components, including a user interface 305, an electronic display 306, and optionally a sensor 310. These components of the primary exterior lock interface 302a may be contained in a single physical housing 312 or contained in multiple physical housings. It should be understood that additional and/or alternative components or different component configurations may be utilized.

The electronic display 306 may be configured to display information and/or data to a user of the door smart lock system 300. The electronic display 306 may be a display screen (e.g., LED screen, OLED screen, etc.) or individual elements that have associated lighting devices (e.g., LEDs). The electronic display 306 may be configured, in certain embodiments, to display the lock state of one or more smart locks, an alarm state of a home alarm system of the building associated with the door smart lock system 300, an energy/battery level of the primary exterior lock interface 302a, user presence indications, activity information, and/or other smart lock and alarm related data.

The user interface 305 may be a keypad and include one or more input elements 308a, 308k. The input elements 308a-308j may corresponding to alpha numeric characters. By a user interacting (e.g., pressing, clicking, swiping, touching or otherwise gesturing) with the input element(s) 308a-308j, the user may cause the primary exterior lock interface 302a to transmit control signals to one or more components of smart lock system 300 of the building. These components may include the various smart devices as described in FIGS. 1 and 2, including one or more of the interfaces, hubs, etc., of smart locks, and the control signals may be to configured to cause the one or more of the smart lock interfaces to transition/adjust the lock state of respective locks of doors of the building. The input elements 308a-308j may be used by the user to input an authentication token (e.g., password or keycode) to be compared, by the primary exterior lock interface 302a (or a server or hub) to a stored authentication key. In an embodiment, in response to confirming (or receiving an indication from the server or hub of confirmation) that the input authentication token matches the stored authentication key, the primary exterior lock interface 302a may display an indication of the match confirmation (e.g., turn ON an illumination device, output an audio signal, etc.). In response to confirming a match of the authentication token with the authentication key, the user may then selectively control one or more smart locks of the building through interacting one or more of the input elements 308a-308j and the input element 308k. For example, the user may indicate one or more smart locks to transition (e.g., lock or unlock) with the input elements 308a-308j (e.g., select a user input associated with a corresponding smart lock) and then indicate a command to adjust or toggle the lock state with the input element 308k. In response to receiving, by the primary exterior lock interface 302a, the indication to adjust the lock state of the one or more smart locks, the primary exterior lock interface 302a may directly or indirectly transmit a control signal to the one or more smart locks. In some embodiments, the user may interact with the input element 308k in a predefined manner to adjust multiple locks at once. For example, the user may click and hold the input element 308k to lock all of the smart locks of the building upon leaving the building. While the example given above describes clicking and holding the input element 308k, it should be understood that any interaction with the user interface 305 or input elements 308a-308n may be used to adjust one or more of the smart locks of the building. Alternative and/or additional gestures or interactions that may be used by the user to indicate a command to adjust a lock state may include double clicking the input element 308k, swiping a gesture on a touch screen, using a voice command, using a bio authenticator, etc.

In some embodiments, the sensor 310 may provide information to assist in the locking or unlocking. For example, the sensor 310 may be a camera to detect a user and provide information for identification of the user to allow for unlocking of the door in response to identifying a person having access to the building or other portion of the environment. In some embodiments, the camera may detect an individual and execute a locking process in response to the individual not being identified or identified as an unauthorized person. The sensor 310 may be utilized along or in conjunction with other detection, validation, observation, or other elements of the door lock system, or other systems.

In another example, the sensor 310 may be a near-field communication sensor such as a Bluetooth or other communication element. The sensor 310 may communicate with a phone, watch, or similar device to provide information for validation of the device. Once validation is successful, the lock may be actuated. In some embodiments, the door lock system may be actuated in response to a determination of a location of a user relative to a geographic area. For example, a geofence or other region may be established (automatically and/or in response to user input) for locking and/or unlocking. For example, if a user is determined to be entering or exiting the region, a corresponding lock/unlock action may be executed. The location of the user relative to the region may be used alone to execute the lock/unlock function or may be used in conjunction with recognized patterns of behavior and/or schedule that is determined automatically and/or input by the user.

The primary interior lock interface 302b may be mounted over and engage with a manual thumb turn of a dead bolt of a primary door of the building on which the interfaces 302a and 302b are mounted. The primary interior lock interface 302b may include an input element 314, a grip element 316 an indicator 318, a removable battery 320, and/or one or more indicators 322a-322n. The shape and size of the input element 314, grip element 316, indicator 318, and indicators 322 may be different, but perform the same functionality.

More particularly, a back side of the input element 314 may be configured to be placed onto and functionally engage a manual thumb turn of a dead bolt of the primary door upon which the primary interior lock interface 302b is mounted. The input element 314 may be configured to interface with the manual thumb turn so as to turn the manual thumb turn when the input element 314 is turned. The input element 314 may include a grip element 316 with which the user of the door lock system 300 may grip. The input element 314 protrudes away from the input element 314 so as to provide a grippable surface with which the user may interact. As shown in the FIG. 3A, the input element 314 may be circular and the grip element 316 may be a single, linear protrusion from the surface of the input element 314. However, it should be understood that the input element 314 and the grip element 316 may be any suitable shape or geometry that enables a user to rotate the thumb turn that is engage to the grip element 316. The primary interior lock interface 302b may include various alternative and/or replaceable input elements 314 to interface with various differently shaped manual thumb turns. In such embodiments, the input element 314 may be removable and replaceable so as to physically match and engage an indentation, slot, or other engagement feature on a door-side of the primary interior lock interface 302b to engage manual thumb turn installed on the door.

The input element 314 may be manually and/or electrically actuated. For example, a user may rotate the input element 314 90 degrees, which may rotate the manual thumb turn 90 degrees so as to lock/unlock the lock of the door. In some embodiments, the input element 314 is alternatively or additionally electromechanically actuated. In such embodiments, the primary interior lock interface 302b may send control signals to an actuator (e.g., motor) mechanically coupled to the manual thumb turn and/or the input element 314 to cause the input element 314 to rotate clockwise or counterclockwise. That is, the control signals transmitted to the actuator may cause the actuator to adjust a position of the deadbolt of the door from an unlocked to a locked state or a locked state to an unlocked state. The control signals may come from any component (e.g., primary exterior lock interface 302a) of the door lock system 300, from a mobile device (e.g., mobile app executed on the mobile device, hub, computer, etc.).

In some embodiments the input element 314 is not mechanically coupled to the dead bolt of the door, but rather another feature that is controlled by the input element 314 may be directly or indirectly coupled to the lock of the door. In such embodiments, the input element 314 may receive commands and/or interactions from the user which may then cause the primary interior lock interface 302b to transmit control signals to the actuator of the primary interior lock interface 302b to adjust the deadbolt of the primary door.

The indicator 318 may be used to indicate a lock state of one or more smart locks of the building associated with the door lock system 300. In some embodiments, the indicator 318 may indicate the locked state of the primary door. In other embodiments the indicator 318 may show or indicate the locked status of all of the smart locks of the building. For example, the indicator 318 may be used to indicate if all the smart locks of the building are in a locked state. In such embodiments, the indicator 318 may be lit when all locks are locked or be unlit when at least one lock of the building is unlocked. The indicator 318 may be configured to display more than two states. For example, the indicator 318 may display various colors, brightness, hues, etc. to indicate additional states (e.g., armed, battery level, door position, communication status, etc.) of one or more smart locks. While the indicator 318 is shown as a light, it should be understood that the indicator 318 may be any indicator described herein (e.g., speaker, haptic engine, electronic display).

The removable battery 320 may supply energy to the primary interior lock interface 302b and all of the associated electronics and/or components. The removable battery 320 may be configured to be removed from the primary interior lock interface 302b. In some embodiments the primary interior lock interface 302b includes multiple removable batteries 320 which may be alternatively used. For example, a first removable battery 320 may be installed on the primary interior lock interface 302b so as to supply energy to the primary interior lock interface 302b while a second removable battery 320 is being charged. Upon the first removable battery 320 dropping below a certain threshold, the primary interior lock may send an alert or notification to the user of the door lock system 300 of the exceeded threshold. The user may then remove the first removable battery 320 and replace it with the second removable battery 320. In some embodiments, the removable battery 320 is additionally electrically coupled to the primary exterior lock interface 302a and supplies power to the primary exterior lock interface 302a.

The indicators 322a-322n may be used to indicate a lock status of one or more smart locks of the building. The indicators 322a-322n may have a first state to indicate a locked state of a corresponding lock and a second state to indicate an unlocked state of the corresponding smart lock. For example, the indicator 322a may be associated with the primary interior lock interface 302B and the indicator 322n may be associated with a secondary lock interface 304 of FIG. 3B. The indicator 322a may be lit (e.g., the first state) when the primary interior lock interface 302b is in the locked state and unlit (e.g., the second state) when the primary interior lock interface 302b is in the unlocked state. Likewise, the indicator 322n may be lit when the secondary lock interface 304 of FIG. 3B is in a locked state and the indicator 322n may be unlit when the secondary lock interface 304 of FIG. 3B is in an unlocked state. The indicator 322a may display the lock state of the primary interior lock interface 302b simultaneously as the indicator 322n displays the lock state of the secondary lock interface 304. While FIG. 3A illustrates the indicators 322a-322n as being visual indicators (for example LEDs), it should be understood that the indicators 322a-322n may be any suitable mechanism and/or device and/or component that may be used to indicate to the user a lock state of each lock of the building. Alternative or additional indicators may include haptic devices, displays, and/or speakers that output audible signals or messages. The indicators 322a-322n may be configured to display more than two states. For example, the indicators 322a-322n may display various colors, brightness, hues, etc. to indicate additional states (e.g., armed, battery level, door position, etc.) of one or more smart locks.

As with the user interface 305 of the primary exterior lock interface 302a, the input element 314 may be used to control the locked state of one or more smart locks of the building. By way of example, the input element 314 may be adjusted to a first orientation (clockwise 90 degrees) to individually lock the primary interior lock interface 302b of the building while a second orientation (counterclockwise 90 degrees) may collectively lock all of the smart locks of the building. For example, rotating the input element 314 to the first orientation (e.g., 45 degrees) may cause a transmission of a control signal to lock the primary interior lock interface 302b of the building. Rotating the input element 314 to the second orientation (e.g., 90 degrees) may cause a transmission of control signals to one or more (e.g., all) of the smart locks of the building to potentially change their states to a locked state if currently in an unlocked state. The primary interior lock interface 302b may send a single control signal that is transmitted or broadcast to some or all of the smart locks or different control signals to each smart lock. In some embodiments, the primary interior lock interface 302b may transmit a single control signal to a single component (e.g., a hub), which may then transmit control signals to one or more of the smart locks (e.g., to any smart locks that are known to be unlocked).

The above first and second orientations are given for illustrative purposes, and it should be understood that the primary interior lock interface 302b may have multiple orientations corresponding to multiple commands. Additional or alternative orientations may include pushing in the input element 314, pulling out the input element 314 sliding the input element 314, rotating the input element 314 a full 360 degrees, swiping the input element 314, tip/tilting the input element 314, etc. Additionally, the input element 314 may have more than one state in which the user may adjust the input element 314 between orientations. By way of example, the input element 314 may be rotated to the first orientation when the input element 314 is pushed in (a first state) or when the input element 314 is pulled out (a second state). In this embodiment, the primary interior lock interface 302b may transmit distinct communication signals depending on the state of the input element 314. For example, if the input element 314 is adjusted when in the first state (e.g., pushed in), the primary interior lock interface 302b may cause an adjustment to a plurality of locks (e.g., all locks) of the door smart lock system 300. If the input element 314 is adjusted when in the second state (e.g., pulled out) the primary interior lock interface 302b may cause an adjustment to a single lock (e.g., the lock associated with the primary interior lock interface 302b). The input element 314 may have a plurality of states, orientation, positions, etc. that may be combined to cause various discreet and distinct actions, processes, methods, communications etc. Furthermore, this input element 314 or other feature (e.g., push button) may disable the input element 314 from being rotated mechanically or automatically. Still yet, wireless communication may be disabled by a setting of the input element or other feature.

Turning now to FIG. 3B, a secondary lock interface 304 is shown. The secondary lock interface 304 may be substantially similar to the primary interior lock interface 302b of FIG. 3A. In various embodiments, the secondary lock interface 304 may be positioned on a secondary door (i.e., not a door on which the primary exterior and interior lock interfaces 302a and 302b are positioned) of the building. In an embodiment, the door smart lock system 300 may include a single primary exterior lock interface 302a, a single primary interior lock interface 302b, and a plurality of secondary lock interfaces 304. The secondary lock interface 304 may include a housing 324 that contains an input element 326, a grip element 328, an indicator 330, indicators 332a-332n, and/or a removable battery 334. The various descriptions and embodiments as described in relation to the primary interior lock interface 302b may extend to, and apply, to the secondary lock interface 304.

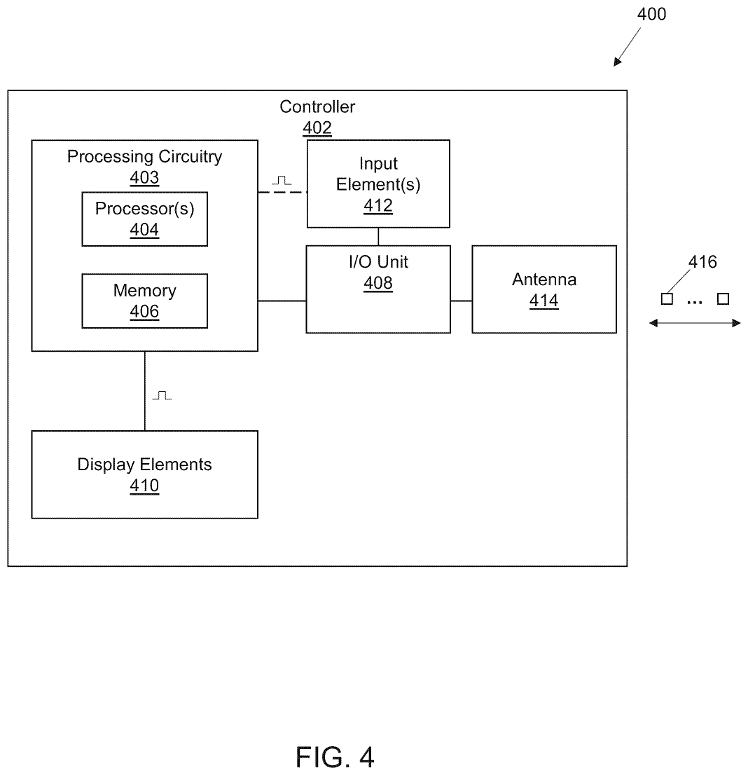

Turning now to FIG. 4, a block diagram of illustrative circuitry 400 of a controller 402 for use in controlling and operating one or more smart locks positioned on or about a space enclosed by one or more walls with at least one entrance is provided. The circuitry 400 may be formed of multiple electronic circuits and modules, including processing circuitry 403 including one or more processors 404 and a memory 406, an input/output unit 408, one or more display elements 410, input element(s) 412, antenna(s) 414 for communicating signals 416 (e.g., communication signals, control signals, data signals, etc.) over one or more frequency bands and using one or more different communication protocols, and so on. The processor(s) 404 may general processors, image processors, digital signal processors, application specific integrated circuits, and/or otherwise configured to execute software to manage operations of the processing circuitry 403 for communicating with and operating the smart lock(s). It should be understood that other components, such as camera(s) speaker(s), illumination devices(s), biometric sensors, motion sensor(s), range sensor(s), or otherwise may be integrated into the controller 402 and be supported by the processing circuitry 403, software being executed thereby, and/or other electronic components.

Turning now to FIG. 5, an illustrative smart lock system 500 is shown. The smart lock system 500 may include an existing lock 502 and a secondary interior lock interface 504. According to some embodiments, the secondary interior lock interface 504 may be substantially similar to the secondary lock interface 304 of FIG. 3B. The secondary lock interface 504 may include an input element 526. The input element 526 may have an indicator 530 and a grip element 528 for gripping the input element 526, and be configured to facilitate a user's interaction with the input element 526. The existing lock 502 may include an existing thumb turn 506, where the existing thumb turn 506 is mechanically coupled to a lock (e.g., a deadbolt) of a door upon which the existing lock 502 is mounted. In some embodiments, the secondary lock interface 504 is configured to be mounted over the existing lock 502 such that the input element 526 and/or the grip element 528 is physically coupled to the existing thumb turn 506. In this configuration, the user's interaction with the input element 526 (e.g., turning) is transferred to the existing thumb turn 506 through the physical coupling between the existing thumb turn 506 and the input element 526 and/or grip element 528. As previously described, the grip element 528 may be hollow and fit onto the existing thumb turn 506.

In some embodiments, the secondary lock interface 504 may have a configurable element coupled to the input element 526, the configurable element may be configured to adjust to a variety of configurations (e.g., sizes and shapes) of existing thumb turns 506. In this manner, the secondary lock interface 504 may be mounted onto a number of different existing thumb turns 506 and/or existing locks 502. In some embodiments, the input element 526 is removable. In these embodiments, the system 500 may include multiple input elements 526 that may correspond to different existing thumb turns 506.

Turning now to FIG. 6, an illustrative process 600 for monitoring and displaying states of smart locks is shown. The process 600 may be performed by smart locks on doors of a space (e.g., a house) that use one or more processors executing instructions stored on a non-transitory, computer-readable medium. At step 610, the process 600 may begin by receiving a lock status of one or more smart locks (or smart lock interfaces) of the space. At step 620, the lock status of the smart lock(s) may be displayed on an electronic display. At step 630, the process 600 continues by receiving, by the processor(s), a request to transition the smart lock(s) to a locked state. At step 640, an instruction may be transmitted to the smart lock(s) to transition the lock(s) to the locked state if presently in an unlocked state. At step 650, an updated lock status from the smart lock(s) is received. At step 660, the updated lock status of each of the smart lock(s) is displayed on the electronic display. The electronic display may be an LCD display, multiple LEDs arranged to identify the lock status of respective doors, or otherwise.

It should be understood that the process 600 may include more, fewer, or different steps than described herein. Likewise, the steps described herein with relation to the process 600 may be executed/performed in any order or timing. The order presented herein is for illustrative purposes only and should not be considered limiting. For example, the process 600 may enable a homeowner user to purchase an initial kit with a primary external lock interface, primary internal lock interface, and secondary internal lock interface that enables the user to control a lock state and unlock state of a door on which the primary lock interfaces and secondary internal lock interface are installed. The homeowner may acquire one or more secondary internal lock interfaces to add automated and remote locking capabilities to another door of a house. In an embodiment, each new secondary internal lock interface may be added to the system and be configured to be communicatively added to the network or system of lock interfaces. The addition of each new secondary internal lock interface may be automated (e.g., system identification of all and/or new lock interfaces by a hub, primary external lock interface, and/or secondary internal lock interface(s)) or manual (e.g., user enter network ID of a new secondary internal lock interface into hub). Once the new secondary internal lock interface(s) are identified and integrated into the locking system, commands or actions by the user to lock or unlock individual and/or all locks on the system include commanding the added secondary internal lock interface(s) to also follow commands (or allow commands to be created and communicated to the other lock interfaces). Still yet, status indicators (e.g., LEDs) that are displayed on the secondary internal lock interfaces may also display status of any new secondary internal lock interfaces added (e.g., ON/OFF indicators). If the number of secondary interior lock interfaces is less than a total number of status indicators (e.g., 2 doors out of a possible 5 status indicators), the status indicators may display ON/OFF indicators to indicate lock (e.g., red or ON) or unlock (e.g., green or OFF) status of each of the lock interfaces while optionally displaying an unused status indicator (e.g., yellow) or simply not displaying any status by maintaining those status indicators in an OFF state. By enabling a user to acquire a smaller number of lock interfaces and then expand, the system may be configurable and scalable to form a more complete and flexible home locking system. Similarly, if secondary interior lock interface(s) are removed, status indicators and communications to those secondary interior lock interface(s) may cease.

Turning now to FIG. 7A, an illustrative process 700 performed by a primary exterior lock interface is shown. The process 700 may be performed by the primary exterior lock interface utilizing one or more processors executing instructions stored on a non-transitory, computer-readable medium. At step 705, an entry code (e.g., access code, authentication token, or otherwise) may be received by a lock from a user interface of the lock or otherwise (e.g., mobile devices). At step 710, a determination is made as to whether the entry code received in step 705 matches a stored authentication key. Responsive to the entry code matching the stored authentication code, the process 700 may continue to step 715, in which one or more indicators may be received. The indicator(s) may be used to lock or unlock one or more doors of an enclosed space. At step 720, a determination of the door(s) to lock or unlock in response to receiving the indicator(s) in step 715 may be made. At step 725, a control signal may be communicated to lock interface(s) associated with the respective door(s) determined to lock or unlock. The control signal may cause the lock interface(s) to transition the associated lock(s) from a locked state to an unlocked state, or vice versa, based on the indicator(s). At step 730, a lock status of the lock(s) associated with the respective door(s) may be displayed. A display on which the lock status is displayed may be an LCD, OLED, LEDs, or otherwise.

It should be understood that the process 700 may include more, fewer, or different steps than described herein, including all methods and processes described in the various figures herein. Likewise, the steps described herein with relation to the process 700 may be executed/performed in any order or timing. The order presented herein is for illustrative purposes only and should not be considered limiting.

Turning now to FIG. 7B, an illustrative process 750 performed by an interior lock interface is shown. The process 750 may be performed by an interior lock interface (e.g., primary interior lock interface, secondary interior lock interface) utilizing one or more processors executing instructions stored on a non-transitory, computer-readable medium. At step 755 a state may be determined from amongst multiple states of a physical element of a lock. At step 760, the process 750 may continue by determining if the physical element transitioned from a first state to a second state. At step 765, responsive to the element transitioning from the first state to the second state, a door associated with the physical element may be unlocked. At step 770, a lock status of the lock associated with a respective door may be displayed. At step 760, responsive to determining that the physical element did not transition from the first state to the second state, a determination may be made at step 775 as to whether the physical element transitioned from the first state to a third state. Responsive to determining that the physical element transitioned from the first state to the third state, the process 750 may continue to step 780 to generate an unlock or lock signal based on the transition of the physical element. At step 790, the lock or unlock signal may be communicated to at least one other lock interface associated with one or more respective doors to cause the lock interface(s) to transition associated lock(s) from a locked state to an unlocked state, or vice versa, based on the transition of the physical element from the first state to the third state. The process 750 may continue to step 770 to display the lock status of the lock(s) associated with the respective door(s) of step 790. The display on which the lock status is displayed may be an LCD, OLED, LEDs, or otherwise.

It should be understood that the process 750 may include more, fewer, or different steps than described herein, including all methods and processes described in the various figures herein. Likewise, the steps described herein with relation to the process 750 may be executed/performed in any order or timing. The order presented herein is for illustrative purposes only and should not be considered limiting.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A kit comprising:
a controller configured to be mounted to correspond to a space with one or more doors and one or more walls to enclose the space;
a first smart lock interface configured to be mounted to an interior of a first door and configured to lock and unlock the first door, the first smart lock interface further configured to communicate with the controller such that a first signal communicated to the first smart lock interface from the controller causes the first smart lock interface to transition from an unlocked state to a locked state or from a locked state to an unlocked state; and
a second smart lock interface configured to be mounted to an interior of a second door and further configured to communicate with the controller such that a second signal communicated to the second smart lock interface from the controller causes the second smart lock interface to transition from an unlocked state to a locked state or from a locked state to an unlocked state.

2. The kit of claim 1, wherein the first smart lock interface is configured to replace a deadbolt on the first door, thereby enabling the first smart lock interface to transition from a locked state to an unlocked state and vice versa.

3. The kit of claim 1, wherein the second smart lock interface is configured to fit over a manual thumb turn of a deadbolt on the second door, thereby enabling the second smart lock interface to rotate the manual thumb turn from a locked state to an unlocked state and vice versa.

4. The kit of claim 1, wherein the controller is configured to communicate with one of the first smart lock interface and the second smart lock interface via a hub, a cloud network, mobile phone network, local area network, or wide area network.

5. The kit of claim 1, wherein the second smart lock interface is configured to communicate directly or indirectly with the first smart lock interface.

6. The kit of claim 1, wherein the first smart lock interface and/or the second smart lock interface further includes indicators that indicate a status of each of the first smart lock interface and the second smart lock interface.

7. The kit of claim 1, wherein the controller includes a user interface inclusive of a lock control mechanism that, responsive to receiving an access code, transitions the lock control mechanism from a first state to a second state by causing the controller to generate the first signal that is communicated to the first smart lock interface to cause the first smart lock interface to transition to a locked state.

8. The kit of claim 7, wherein the controller is configured to generate the second signal that is communicated to the second smart lock interface to cause the second smart lock interface to transition to a locked state.

9. The kit of claim 8, wherein the lock control mechanism is configured to enable a user to transition the lock control mechanism from the first state to a third state to cause the controller to generate the second signal in addition to the first signal.

10. The kit of claim 9, wherein the first signal and the second signal are the same signal.

11. The kit of claim 7, wherein the user interface is a keypad.

12. The kit of claim 1, wherein the first smart lock interface and the second smart lock interface are configured to communicate with one another, and wherein each of the first smart lock interface and the second smart lock interface are configured to generate a third signal that are communicated to the other of the first smart lock interface and the second smart lock interface to cause the other of the first smart lock interface and the second smart lock interface to transition from the unlocked state to the locked state or from the locked state to the unlocked state.

13. The kit of claim 1, wherein the kit includes packaging that encloses the controller, the first smart lock interface, and the second smart lock interface.

14. A security system, comprising:
a controller configured to be mounted on an exterior of a space with multiple doors and one or more walls to enclose the space;
a first smart lock interface configured to be mounted to an interior of a first door and configured to lock and unlock the first door, the first smart lock interface further configured to communicate with the controller such that a first signal communicated to the first smart lock interface from the controller causes the first smart lock interface to transition from an unlocked stated to a locked state or from a locked state to an unlocked state; and
a second smart lock interface configured to be mounted to an interior of a second door and further configured to communicate with the controller such that a second signal communicated to the second smart lock interface from the controller causes the second smart lock interface to transition from an unlocked state to a locked state or from a locked state to an unlocked state.

15. The security system of claim 14, the first smart lock interface is configured to fit over a manual thumb turn of a deadbolt on the first door.

16. The security system of claim 14, wherein the controller is configured to communicate with one of the first smart lock interface and the second smart lock interface via a hub, a cloud network, mobile phone application.

17. The security system of claim 14, wherein the first smart lock interface or the second smart lock interface further includes indicators that indicate a status of each smart lock.

18. The security system of claim 14, wherein the first smart lock interface and the second smart lock interface are configured to communicate with one another and wherein each of the first smart lock interface and the second smart lock interface are configured to generate a third signal to be communicated to the other of the first smart lock interface and the second smart lock interface to cause the other of the first smart lock interface and the second smart lock interface to transition from the unlocked state to the locked state or from the locked state to the unlocked state.

19. A method, comprising:
receiving, by one or more processors, a lock status of one or more smart locks associated with a space with multiple doors and one or more walls to enclose the space;
displaying, by the one or more processors, the lock status of the one or more smart locks on an electronic display;
receiving, by the one or more processors, a request to transition the one or more smart locks to a locked state;
transmitting, by the one or more processors, an instruction to the one or more smart locks to transition the one or more smart locks to the locked state if presently in an unlocked state;
receiving, by the one or more processors, an updated lock status from each of the one or more smart locks associated with the space; and
displaying, by the one or more processors, the updated lock status of each of the one or more smart locks on the electronic display.

20. The method of claim 19, wherein displaying the lock status of the one or more smart locks includes illuminating or not illuminating an illumination device associated with respective smart locks.
